(19) United States
(12) Patent Application Publication
(10) Pub. No.: US 2012/0261216 A1
(43) Pub. Date: Oct. 18, 2012

(54) STAIRLIFT WITH FOLDING TRACK

(75) Inventors: Robert D. Hrenchir, Paola, KS (US); Mark L. Hill, Greenwood, MO (US); Mark S. Jackson, Greenwood, MO (US)

(73) Assignee: Harmar Summit, LLC, Lake Winnebago, MO (US)

(21) Appl. No.: 13/087,452

(22) Filed: Apr. 15, 2011

(51) Int. Cl. B66B 9/08

(52) U.S. Cl. 187/201

(57) ABSTRACT

A stair lift includes a track, a carriage, a drive mechanism and a folding mechanism. The track has a main track section and a lower track section. The lower track section is pivotally mounted to the main track section and is moveable between a lowered position and a raised position. The folding mechanism shifts the lower track section to its lowered position whenever the carriage and seat approach the lowermost stairs and lifts the lower track section to its raised position as the carriage and seat move up the stairway. The folding mechanism is actuated and powered by movement of the carriage and does not require its own motor, cylinder, or other actuator.

### BACKGROUND

Stair lifts are often used to transport elderly, handicapped, and/or disabled people up and down stairways or other inclined surfaces. Conventional stair lifts comprise a track configured to be mounted above a stairway; a carriage with a seat supported on the track; and a drive mechanism for moving the carriage and seat along the track and thus up or down the stairway. The lowermost end of the track typically overhangs or extends a distance beyond and below the first step of the stairway to allow users to easily mount and dismount the seat on the stair lift carriage. This can be a problem because the lower end of the track often obstructs or interferes with doors or other objects positioned near the bottom of the stairway.

To address this problem, many stair lifts are now equipped with tracks having folding lower sections that can be folded upward when the stair lifts are not in use or when the carriages have moved away from the lowermost steps.

### SUMMARY

Existing stair lifts with folding tracks include separate motors and/or cylinders for shifting the folding lower sections between their lowered and raised positions. This is undesirable because the additional motors or cylinders increase the cost, complexity, and power usage of the stair lifts. Moreover, the extra motors and cylinders necessitate extra control and safety circuits to ensure that the folding lower track sections always operate in proper sequence with the movement of the carriage.

The present invention solves the above-described problems and provides a distinct advance in the art of stair lifts with folding tracks. More particularly, the present invention provides a stair lift with a folding track that does not require extra motors, cylinders, control features, etc. to actuate the folding track.

A stair lift constructed in accordance with an embodiment of the invention broadly comprises a track, a moving carriage with a drive mechanism, and a folding mechanism. The stair lift may also comprise conventional controls, safety features, and other components commonly found on stair lifts.

The track is configured to be mounted above a stairway and has a main track section and a lower track section. The lower track section is pivotally mounted to the main track section and is moveable between a lowered position and a raised position. The carriage is supported on the track and supports a seat or bench on which a person sits.

The drive mechanism is coupled with the track and the carriage for moving the carriage along the track and thus up or down the stairway. The drive mechanism may comprise a motor-driven belt system, rack and pinion system, chain system, worm gear system, cable winch, or any other known drive mechanism.

The folding mechanism shifts the lower track section between its lowered and raised positions. Specifically, the folding mechanism shifts the lower track section to its lowered position whenever the carriage and seat approach the lowermost stairs and the mechanism lifts the lower track section to its raised position as the carriage and seat move up the stairway. Importantly, the folding mechanism is actuated and powered by movement of the carriage and does not require its own motor, cylinder, or other actuator.

One embodiment of the folding mechanism comprises a fork pivotally connected to the main track section, a lever connected to the lower track section, and a link connected between the fork and the lever. The fork pivots as it engages a pin extending from the carriage to lower the lower track section when the carriage approaches the lower track section. The fork pivots in the opposite direction to raise the lower track section when the carriage moves away from the lower track section. The pin may have a roller on it to reduce jarring of the fork when it engages the pin.

An embodiment of the fork comprises two spaced-apart teeth that define a slot between the teeth. When the carriage approaches the fork, the pin and roller extending from the carriage enter the slot in the fork. As the carriage continues to move, the pin and roller pivot the fork, which in turn pushes or pulls on the link to pivot the lever and thereby raise or lower the lower track section.

By constructing a stair lift as described herein, numerous advantages are realized. For example, because the lower track section is raised and lowered by movement of the carriage on the track, a separate motor, cylinder, or other actuator is not required for this purpose, thus decreasing the cost, complexity, and power usage of the stair lift. Furthermore, because of the configuration and operation of the shifting mechanism, a single shifting mechanism serves to both lower and raise the lower track section.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a fragmentary rear perspective view of a stair lift constructed in accordance with an embodiment of the present invention shown installed on a stairway, with the carriage of the stair lift in its lowermost position.

FIG. 2 is another fragmentary rear perspective view of the stair lift shown from a different angle but with the carriage still in its lowermost position.

FIG. 3 is a fragmentary rear elevational view of the stair lift with the carriage shown in its lowermost position.

FIG. 4 is a fragmentary rear perspective view of the stair lift with the carriage shown either a) initially engaging the fork of the shifting mechanism as the carriage travels up the track or b) disengaging the fork as the carriage travels down the track.

FIG. 5 is a fragmentary rear elevational view of the stair lift with the carriage shown in essentially the same position as FIG. 4.

FIG. 6 is a fragmentary rear perspective view of the stair lift with the carriage further up the track relative to the position shown in FIGS. 4 and 5.

FIG. 7 is a fragmentary rear elevational view of the stair lift with the carriage shown in essentially the same position as FIG. 6.

FIG. 8 is a fragmentary rear perspective view of the stair lift with the carriage shown further up the track relative to the position shown in FIGS. 6 and 7.

FIG. 9 is a fragmentary rear elevational view of the stair lift with the carriage shown in generally the same position as FIG. 8.

FIG. 10 is an enlarged perspective view of a portion of the carriage with its cover removed.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

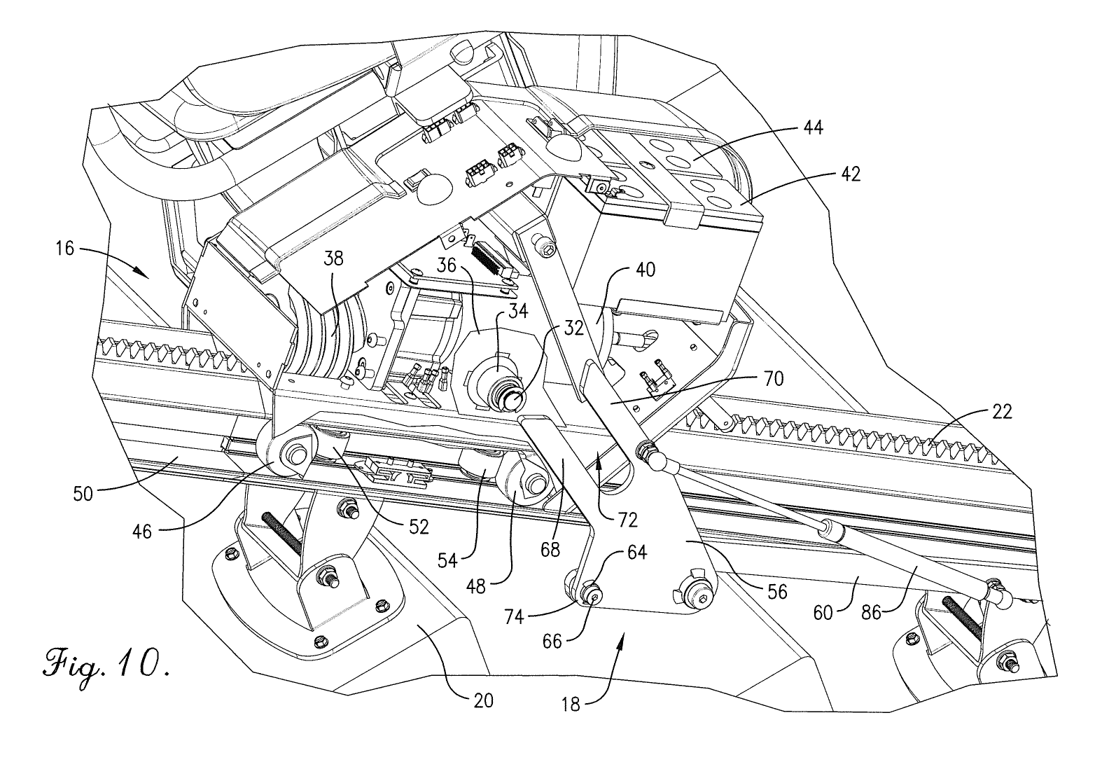

Turning now to the drawing figures, a stair lift 10 constructed in accordance with an embodiment of the invention is illustrated. The stair lift 10 broadly comprises a track 12, a carriage 14, a drive mechanism 16 (shown primarily in FIG. 10), and a folding mechanism 18. The stair lift 10 may also comprise conventional controls, safety features, and other components not described in detail herein.

The track 12 is configured to be mounted above a stairway 20 or other area to be traversed by the carriage 14 and is similar to tracks of conventional stair lifts. An embodiment of the track includes a rack 22 with teeth for engagement by a pinion or worm gear as described in more detail below. The track may be any length and constructed of any suitable materials.

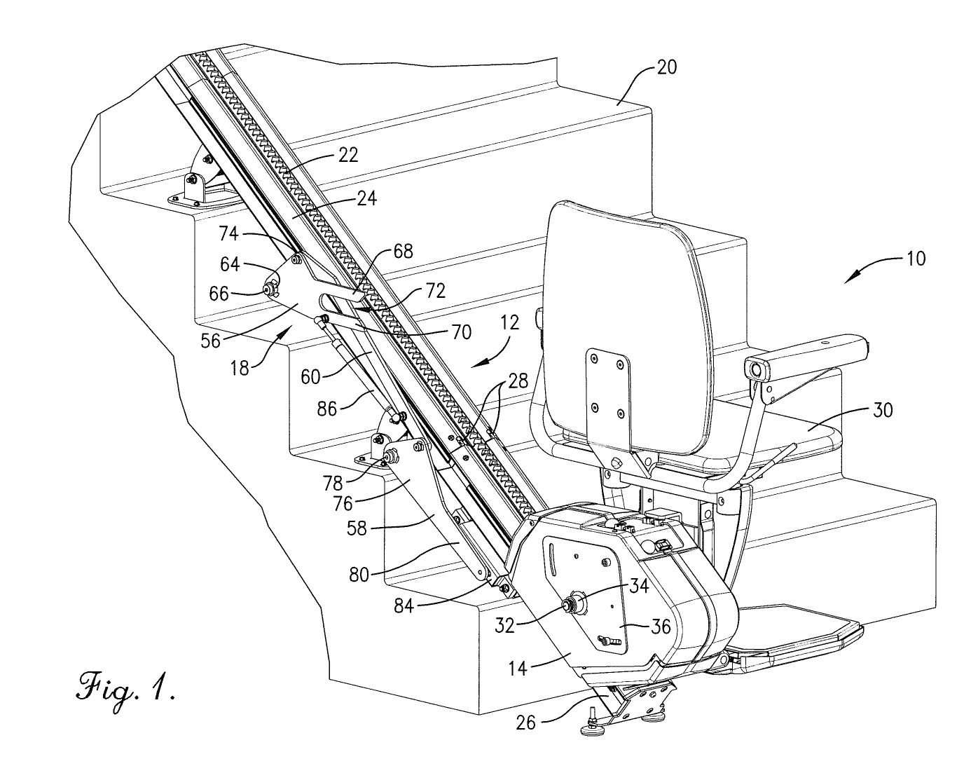

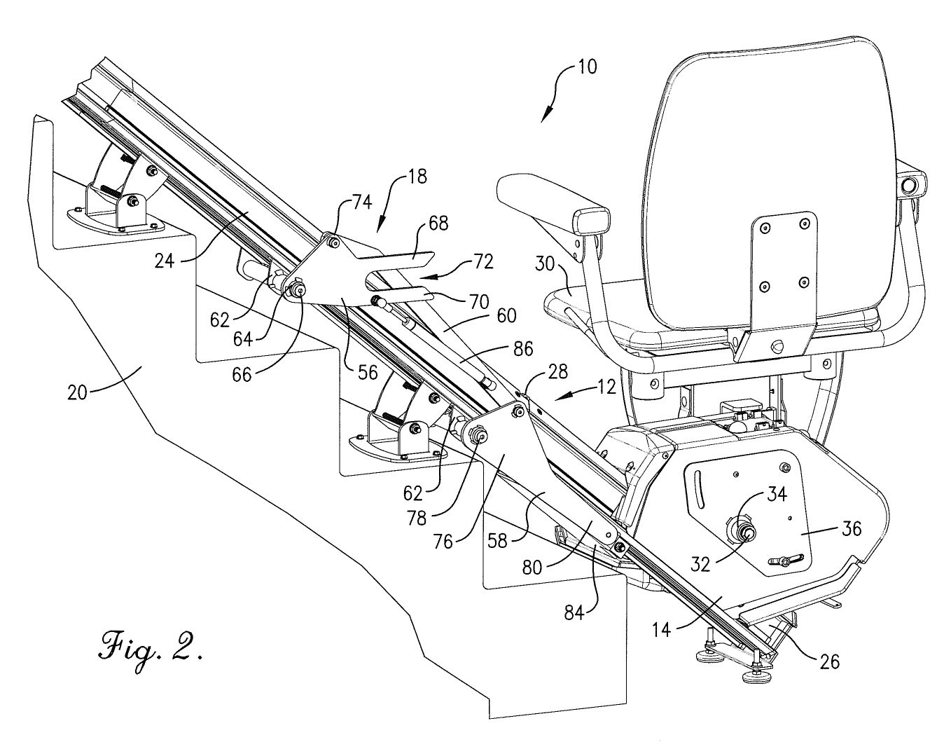

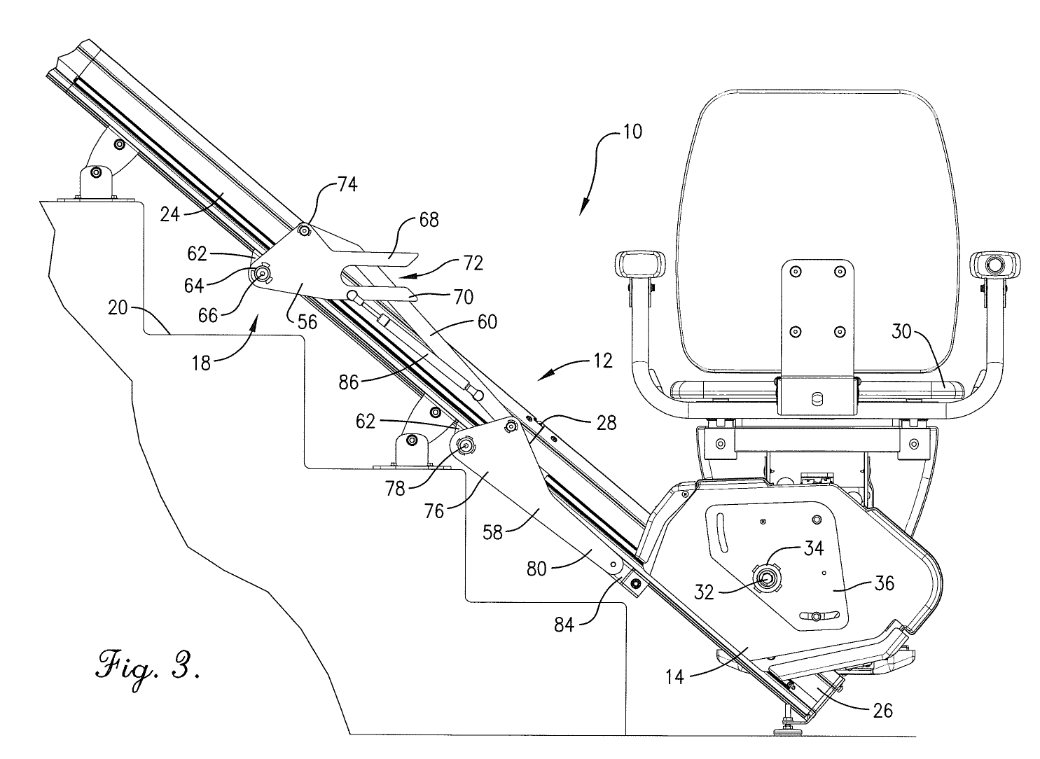

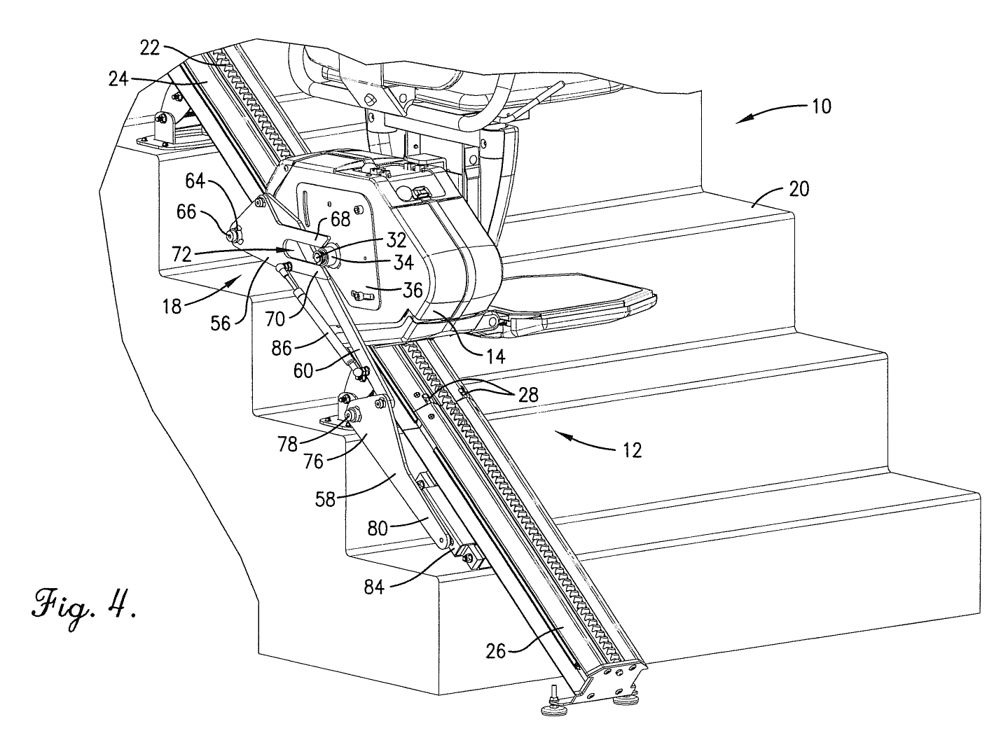

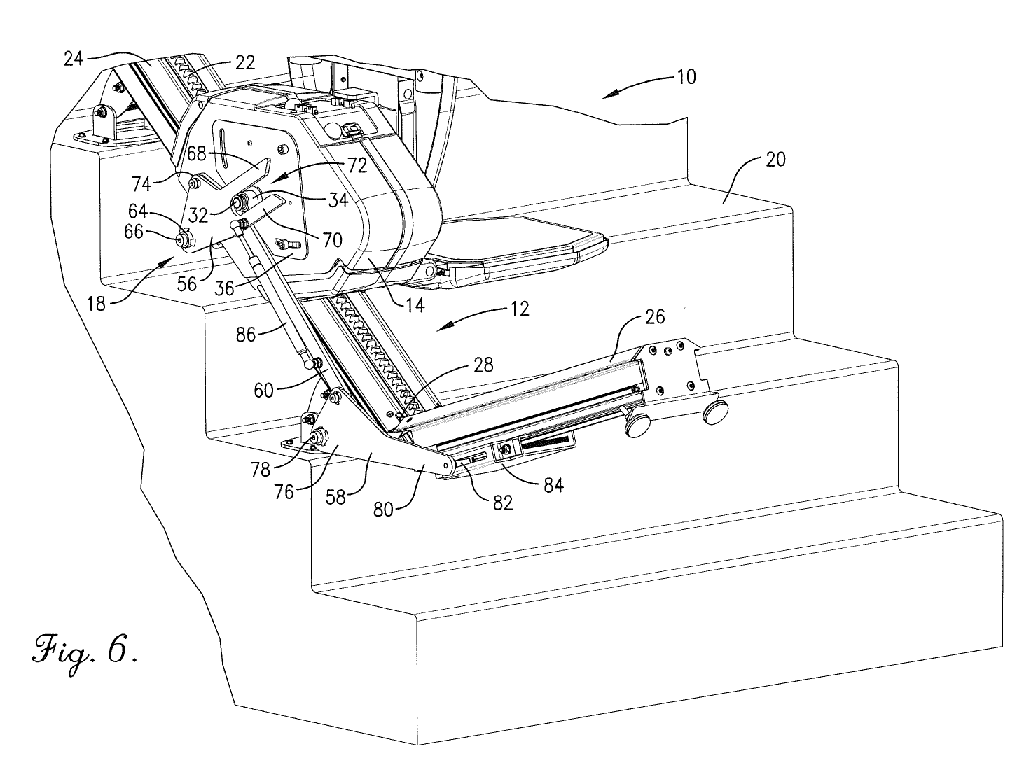

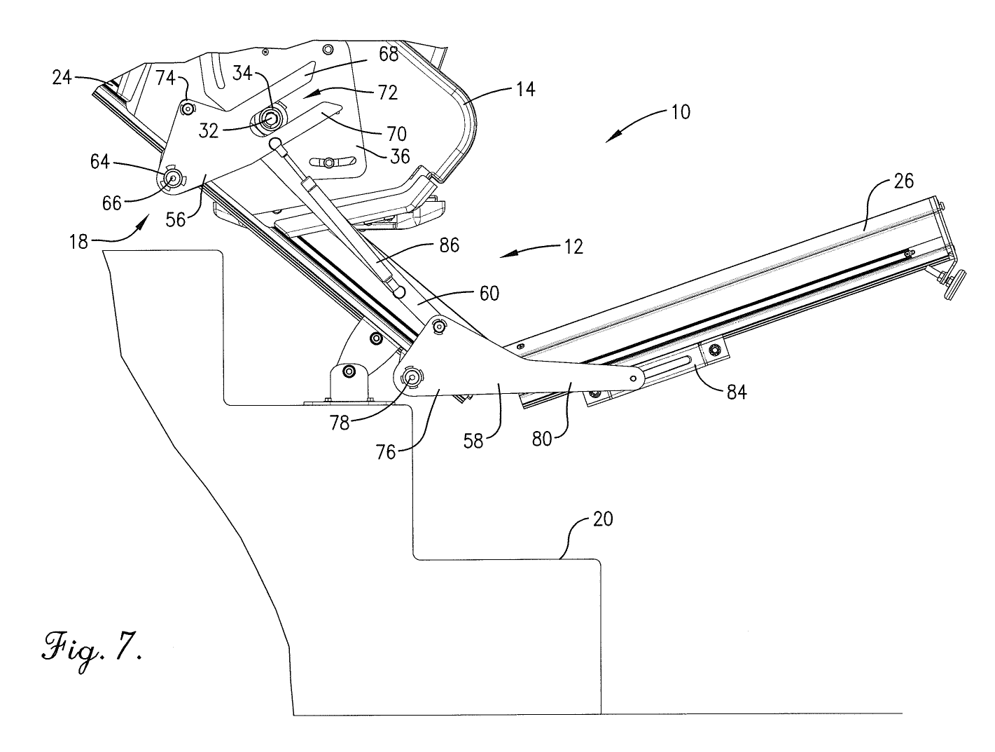

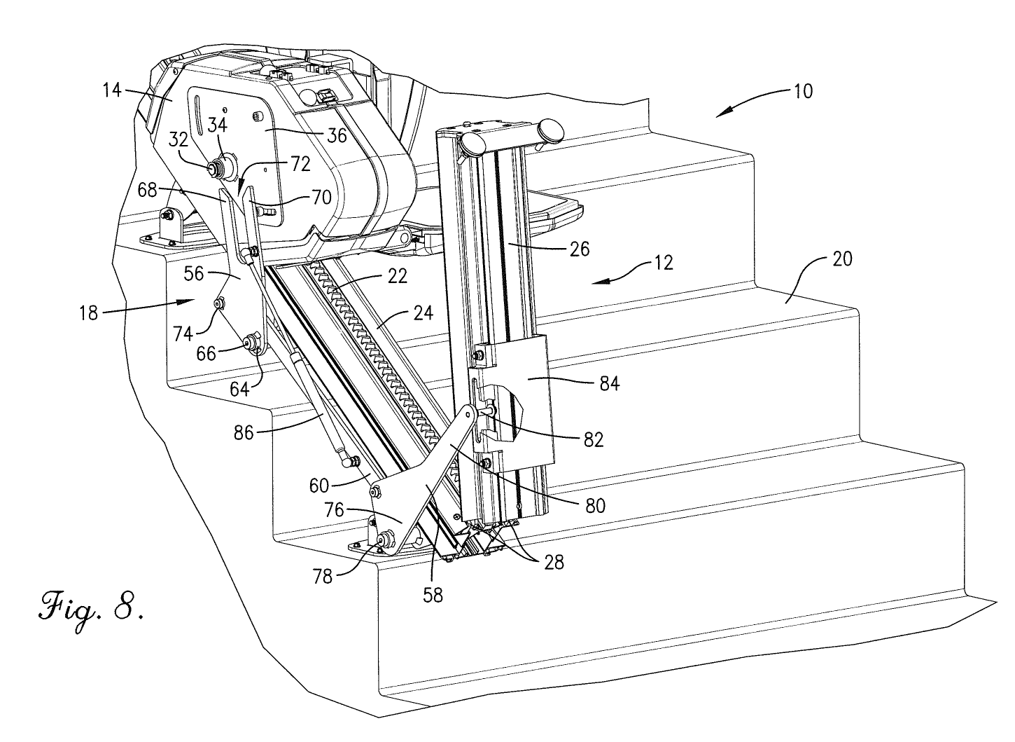

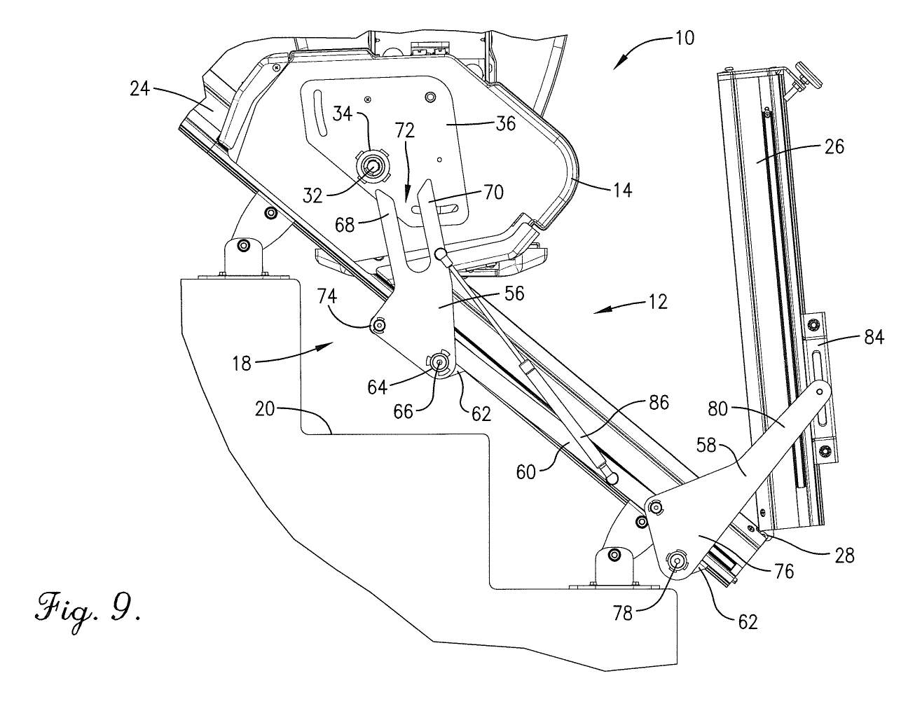

As best illustrated in FIGS. 4, 6, and 8, the track 12 comprises a main track section 24 that spans the entire stairway except for the bottommost stair, and a lower track section 26 that generally spans the bottommost stair or a portion thereof. The lower track section 26 is pivotally mounted to the main track section 24 by hinges 28 and is moveable between a lowered position depicted in FIGS. 1-5, and a raised position depicted in FIGS. 8 and 9. Intermediate positions of the lower track section are shown in FIGS. 6 and 7.

The carriage 14 is supported on the track 12 and may support a seat 30, bench, or other support on which a person sits. The carriage 14 and its seat 30 move up and down the track 12 under power of the drive mechanism 16. The carriage 14 may enclose and/or support many of the drive mechanism components, controls, and safety mechanisms of the stair lift.

As best illustrated in FIGS. 1 and 10, a fork-engaging pin 32 with an outer roller 34 extends from the rear side of the carriage 14. The pin 32 is mounted to a support plate 36 that is in turn mounted to the carriage 14. The pin 32 and roller 34 interact with the folding mechanism 18 to raise and lower the lower track section 26 as described below.

The drive mechanism 16 is coupled with the track 12 and the carriage 14 for moving the carriage along the track and thus up or down the stairway. The drive mechanism 16 may comprise a motor-driven belt system, rack and pinion system, chain system, worm gear system, or any other known drive mechanism. As best shown in FIG. 10, an embodiment of the drive mechanism 16 comprises a rotatable pinion or worm gear 38 for engaging the teeth on the rack 22, an electric motor 40 for driving the pinion or worm gear 38, and one or more rechargeable batteries 42, 44 for powering the motor 40. The drive mechanism 16 may also comprise a pair of wheels 46, 48 that ride along an outboard edge 50 of the track 12 and a pair of guide rollers 52, 54 that keep the carriage 14 centered on the track 12.

The folding mechanism 18 cooperates with the pin 32 and roller 34 on the carriage 14 to shift the lower track section 26 between its lowered and raised positions. Specifically, the folding mechanism 18 shifts the lower track section 26 to its lowered position whenever the carriage 14 and seat approach the lowermost stairs and shifts the lower track section 26 to its raised position as the carriage and seat move up the stairway away from the lowermost stairs. Importantly, the folding mechanism 18 is actuated and powered by movement of the carriage 14 and does not require its own motor, cylinder, or other actuator.

One embodiment of the folding mechanism 18 comprises a fork 56, a lever 58, and a link 60. The fork 56 is pivotally connected to a brace 62 on the main track section or another support surface by a bushing 64 on a pin 66 that extends through a pin-receiving hole in the fork. An embodiment of the fork 56 includes two spaced-apart teeth 68, 70 that define a slot 72 between the teeth. The distal ends of the teeth 68, 70 are angled outwardly so as to form an enlarged opening communicating with the slot 72. As described in more detail below, the slot 72 receives the roller 34 on the pin 32 whenever the carriage 14 travels by the fork 56. An outwardly projecting portion of the fork serves as an attachment lug 74 for coupling with the link 60 as described below.

The lever 58 shifts the lower track section 26 between its lowered and raised positions under the influence of the fork 56 as described below. An embodiment of the lever 58 is perhaps best illustrated in FIGS. 8 and 9 and includes a first end 76 pivotally connected to the main track section or another support by a pivot roller 78. A pin 82 extends from a second end 80 of the lever and is received within a slotted bracket 84 attached to the lower track section.

The link 60 is connected between the fork 56 and the lever 58 for moving the lever 58 and hence the lower track section 26 upon movement of the fork 56. An embodiment of the link 60 comprises a metal bar having a first end bolted or otherwise attached to the attachment lug 74 of the fork 56 and an opposite end bolted or otherwise attached to the lever 58.

The folding mechanism 18 may also include a compression spring-cylinder 86. The compression cylinder 86 in this embodiment is mounted between the fork 56 and the link 60 and helps lift the lower track section 26 by providing force to offset much of the weight of the lower track section. The cylinder 86, as a secondary function, also retains the lower track section 26 in its raised position once the carriage as traversed up the track 24 past the folding mechanism 18. Upon folding down, the cylinder 86 exerts its force on the lever 58 to provide positive force to assist gravity in holding the lower track section in its lowered position. The cylinder 86 may be a gas cylinder, a spring or any other device that provides a similar function.

The folding mechanism 18 is designed so that as the lower track section 26 is moved to its fully-raised position, the pin connected to the link 60 crosses the center of rotation of the fork 56 to become ‘over center’ to prevent force exerted to the raised distal end of lower track section 26 to cause the track to lower unintentionally. This is a safety feature.

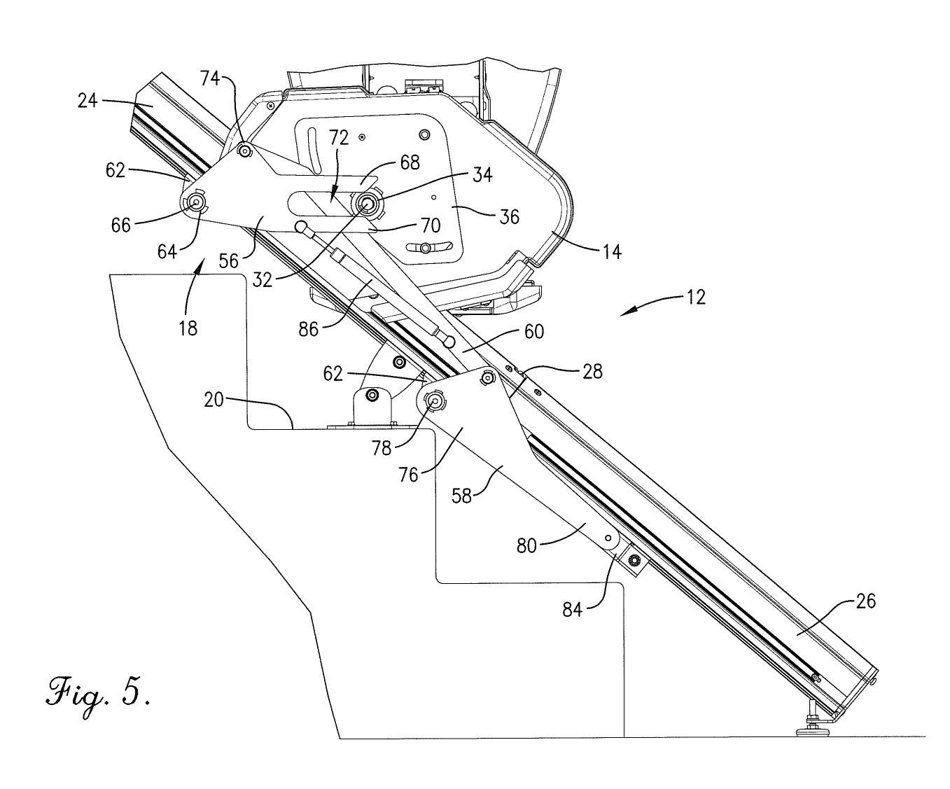

Operation of the stair lift 10 will now be described with reference to the drawing figures. The carriage 14 is initially shown adjacent the lower most stair of the stairway and the lower track section 26 is shown in its fully lowered position in FIGS. 1-3. As the carriage 14 travels up the track 12 away from the lower track section 26, the pin 32 and roller 34 extending from the side of the carriage enter the slot 72 in the fork 56 as shown in FIGS. 4 and 5. As the carriage 14 continues to travel up the track 12, the pin 32 and roller 34 rotate the fork 56 in a counter clockwise direction (in this left-stairway embodiment), thus causing the attachment lug 74 on the fork 56 to pull the link 60 upward and to the left as viewed from the perspective of FIGS. 4 and 5. This causes the lever 58 to pivot in a counter clockwise direction and to pull the lower track section 26 upward toward its raised position. As the lever 58 pivots, its pin 82 moves within the slotted bracket 84 to provide mechanical amplification of the forces moving the lower track section. These movements continue until the carriage 14 and the pin 32 and roller 34 clear the fork 56 as shown in FIGS. 8 and 9. At this point, the lower track 26 is in its fully raised position.

The above described movements are essentially reversed when the carriage 14 travels back down the track. Specifically, as the carriage 14 begins to travel down the track toward the lower track section 26 as depicted in FIGS. 8 and 9, the roller pin 32 and roller 34 enter the slot 72 in the fork 56. As the carriage 14 continues to travel down the track, the pin 32 and roller 34 rotate the fork 56 in a clockwise direction, thus causing the attachment lug 74 on the fork 56 to push the link 60 downward and to the right as viewed from the perspective of FIGS. 6 and 7. This causes the lever 58 to pivot in a clockwise direction and push the lower track section 26 downward toward its lowered position. These movements continue until the carriage 14 approaches its lower most position shown in FIGS. 1-3. At this point, the lower track 26 is in its fully lowered position so that the carriage 14 may reach the bottom most stairs of the stairway.

In another embodiment of the invention, the above-described folding mechanism 18 may be replaced with a hydraulic system, an air system, a spring system, or a battery system that harnesses energy from movement of the carriage 14 and uses that energy to shift the lower track section 26 between its lowered and raised positions.

By constructing a stair lift as described herein, numerous advantages are realized. For example, because the lower track section is raised and lowered by movement of the carriage on the track, a separate motor or cylinder is not required for this purpose, thus decreasing the cost, complexity, and power usage of the stair lift. Furthermore, because of the configuration and operation of the shifting mechanism, a shifting mechanism serves to both lower and raise the lower track section.

Although the invention has been described with reference to the preferred embodiment illustrated in the attached drawing figures, it is noted that equivalents may be employed and substitutions made herein without departing from the scope of the invention as recited in the claims. For example, the specific shape and size of the stair lift and the components of the shifting mechanism may be changed without departing from the scope of the invention.

Having thus described the preferred embodiment of the invention, what is claimed as new and desired to be protected by Letters Patent includes the following:

1. A stair lift comprising:
a track configured to be mounted above a stairway, the track having a main track section and a lower track section pivotally mounted to the main track section and moveable between a lowered position and a raised position;
a carriage supported on the track;
a drive mechanism for moving the carriage along the track and thus up or down the stairway; and
folding mechanism for shifting the lower track section between its lowered and raised positions, wherein the folding mechanism is triggered to raise or lower the lower track section when the carriage contacts a component of the folding mechanism.

2. The stair lift as set forth in claim 1, the folding mechanism comprising:
a fork which may pivot;
a lever which may pivot to raise or lower the lower track section; and
a link connected between the fork and the lever;
wherein the fork is configured to operate the link and the lever to lower the lower track section as the carriage approaches the lower track section and to raise the lower track section as the carriage moves away from the lower track section.

3. The stair lift as set forth in claim 2, wherein the link is pivotally attached to the fork such that as the lower track section is raised by the link, the pivot point between the link and the fork travels across the rotational center of the fork, preventing the lower track section from being able to be lowered unintentionally.

4. The stair lift as set forth in claim 3, the fork comprising:
two spaced-apart teeth that define a slot between the teeth; and
an attachment lug.

5. The stair lift as set forth in claim 4, the link having a first end coupled with the attachment lug of the fork and a second end coupled with the lever.

6. The stair lift as set forth in claim 1, the drive mechanism comprising a motor-driven belt system, a motor-driven rack and pinion system, a motor-driven chain system, or a motor-driven worm gear system.

7. A stair lift comprising:
a track configured to be mounted above a stairway, the track having a main track section and a lower track section that is mounted to the main track section by a hinge and moveable between a lowered position and a raised position;
a carriage supported on the track;
a drive mechanism for moving the carriage along the track and thus up or down the stairway; and
folding mechanism connected with the lower track section for shifting the lower track section between its lowered and raised positions, the folding mechanism using energy from movement of the carriage to raise and lower the lower track section.

8. The stair lift as set forth in claim 7, the folding mechanism comprising a hydraulic system, an air system, a spring system, or a battery system that harnesses energy from movement of the carriage on the track and uses the energy to shift the lower track section between its lowered and raised positions.

9. The stair lift as set forth in claim 7, the folding mechanism comprising:
a fork;
a lever; and
a link connected between the fork and the lever;
wherein the fork is configured to operate the link and the lever to lower the lower track section as the carriage approaches the lower track section and to raise the lower track section as the carriage moves away from the lower track section.

10. The stair lift as set forth in claim 9, the fork comprising:
two spaced-apart teeth that define a slot between the teeth; and
an attachment lug.

11. The stair lift as set forth in claim 10, the link having a first end coupled with the attachment lug of the fork and a second end coupled with the lever.

12. The stair lift as set forth in claim 7, the drive mechanism comprising a motor-driven belt system, a motor-driven rack and pinion system, a motor-driven chain system, or a motor-driven worm gear system.

13. A stair lift comprising:
a track configured to be mounted above a stairway, the track having a main track section and a lower track section that is pivotally mounted to the main track section and moveable between a lowered position and a raised position, wherein the lower track section is coupled to the main track section by a hinge;
a carriage supported on the track;
a drive mechanism for moving the carriage along the track and thus up or down the stairway; and
folding mechanism for shifting the lower track section between its lowered and raised positions, the folding mechanism comprising:
a fork;
a lever connected to the lower track section; and
a link connected between the fork and the lever;
wherein the fork is configured to operate the link and the lever to lower the lower track section as the carriage approaches the lower track section and to raise the lower track section as the carriage moves away from the lower track section.

14. The stair lift as set forth in claim 13, the fork comprising:
two spaced-apart teeth that define a slot between the teeth; and
an attachment lug.

15. The stair lift as set forth in claim 13, the link having a first end coupled with the attachment lug of the fork and a second end coupled with the lever.

16. The stair lift as set forth in claim 13, the drive mechanism comprising a motor-driven belt system, a motor-driven rack and pinion system, a motor-driven chain system, or a motor-driven worm gear system.
